(19) United States
(12) Patent Application Publication
(10) Pub. No.: US 2011/0088927 A1
(43) Pub. Date: Apr. 21, 2011

(54) ELECTRICAL SUPPLY BAR ASSEMBLY AND METHOD OF PRODUCING SUCH AN ASSEMBLY

(75) Inventors: Renaud Cuenot, Pontarlier (FR); Didier Bisson, Pontarlier (FR)

(73) Assignee: IDEALEC, Pontarlier (FR)

(21) Appl. No.: 12/937,566

(22) PCT Filed: Apr. 15, 2008
(86) PCT No.: PCT/IB08/51439

§ 371 Date: Dec. 8, 2010

(51) Int. Cl. H01B 3/00; H01B 19/00

(52) U.S. Cl. 174/110 R; 29/887

(57) ABSTRACT

In an assembly comprising an electrically conducting bar, lower and upper electrically insulating films covering opposed faces of the conducting bar, and an electrically insulating member bonded to the upper insulating film, the insulating member protruding on the exposed face of the insulating film so as to prevent propagation of electric arcs by tracking on said exposed face, the insulating member is bonded to the insulating film with a heat-sealable coating.

### BACKGROUND OF THE INVENTION

The invention relates to an electrical supply bar assembly and to a method of producing such an assembly.

Electrical supply bar assemblies are used in high power electrical connection systems, designed for example for car or train electrical motors.

More specifically, the invention relates to an electrical supply bar assembly of the type comprising:
an electrically conducting bar,
lower and upper electrically insulating films covering opposed faces of the conducting bar, and
an electrically insulating member bonded to the upper insulating film opposite to the conducting bar, the insulating member protruding on the exposed face of the insulating film so as to prevent propagation of electric arcs by tracking on said exposed face.

In electrical supplying systems using several electrical supply bar assemblies, the conducting bars thereof are positioned proximate to one another, and are set in operation to different voltages.

The insulating films insulate the different conducting bars from one another. However, a concern with such systems is to avoid electric arcs propagation between exposed regions of the conducting bars intended to allow the connection of different electrical components to the conducting bars for supplying electricity to these components.

Electric arcs can propagate directly through air (air propagation mode) or by tracking, i.e. at the interface between air and the air-exposed surface of the insulating films (tracking propagation mode), or by combination thereof

The chance of propagation of an electrical arc between two exposed regions is lowered if the distance the electrical arc has to run between the two exposed regions is increased.

However, an increase of the distance between the connection regions is made in the detriment of the compactness of the system.

In an electrical supply bar assembly of the above-defined type, the insulating member protruding on the insulating of the film increases a tracking distance for an electric arc passing over the insulating member in a tracking propagation mode.

In conventional electrical supply bar assembly, the insulating member is bonded to the insulating film in a post treatment operation, with an adhesive joint deposited on the insulating film or on the insulating member before pressing the insulating member on the insulating film until the adhesive joint bonds the insulating film and the insulating member.

However, in use, the electrical supply bar assemblies encounter always more severe conditions, such as high voltages, high temperature, high humidity, and high mechanical stress.

The bonding of the insulating member in conventional electrical supply bar assembly has failed to be resistant enough to resist to such severe conditions.

### SUMMARY OF THE INVENTION

It is an object of the invention to provide an electrical supply bar assembly which is able to resist to severe use conditions and to be produced at low cost.

Accordingly, the invention provides electrical supply bar assembly of the above-mentioned type, wherein the insulating member is bonded to the insulating film by a heat-sealable coating.

The heat-sealable coating can be achieved with high quality level which ensures a great bonding resistance. Beside, the heat-sealable coating can be activated by heating in the same step as heat-sealable coatings used to bond the insulating films to the conducting bar.

The invention also relates to a method of producing an electrical supply bar assembly comprising the steps of:
bonding upper and lower insulating films over opposed faces of an electrically conducting bar, and
bonding an electrically insulating member on the upper insulating film, such that the insulating member protrudes on an exposed face of the upper insulating film so as to prevent propagation of electric arcs by tracking along said exposed face,
wherein the method comprises the steps of providing a heat-sealable coating between the upper insulating film and the insulating member and activating said heat-sealable coating by heating.

### BRIEF DESCRIPTION OF THE DRAWINGS

FIG. 1 is a cross sectional view of an electrical supply bar assembly according to the invention, comprising an insulating member and a connection terminal for connecting an electrical component to the bar of the assembly;

FIGS. 2 and 3 are elevation view of electrical supply bar assemblies according to alternatives of the invention, showing different arrangements of an insulating member;

FIGS. 4A and 4B are cross sectional views of the electrical supply bar assembly of FIG. 1, during and after assembly;

FIGS. 5A and 5B are analog to FIGS. 4A and 4B and illustrate an electrical supply bar according to another embodiment of the invention;

FIGS. 6A and 6B are analog to FIGS. 4A and 4B and illustrate an electrical supply bar according to still another embodiment of the invention;

FIG. 7 is a cross sectional view of an assembled electrical supply bar assembly according to another embodiment of the invention; and

FIG. 8 is an enlarged cross sectional view of an electrically insulating member provided with grooves.

### DETAILED DESCRIPTION OF THE PREFERRED EMBODIMENTS

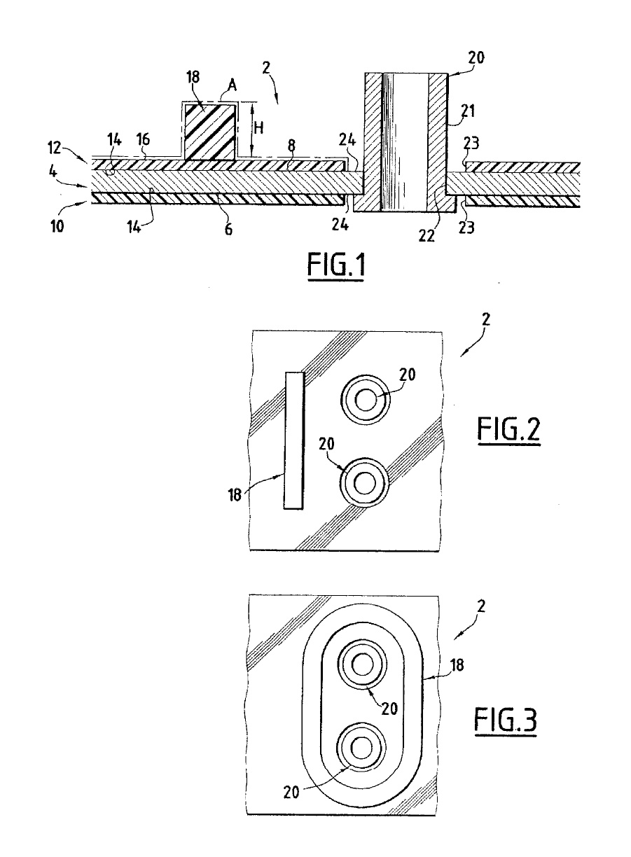

In the embodiment illustrated on FIG. 1, the electrical supply bar assembly 2 comprises a electrically conducting bar 4 having opposed lower 6 and upper 8 faces covered with lower 10 and upper 12 insulating films each having an internal face 14 orientated towards the bar 4 and an external exposed face 16 orientated opposite to the bar 4.

Typically, the thickness of the insulating film is comprised between 0.1 mm and 1.5 mm.

The assembly 2 comprises an electrically insulating member 18, for instance a rib. The rib 18 is bonded to the face 16 of film 12 and protrudes on said face 16. The rib 18 is elongated and has in this instance a substantially square transverse section. In an alternative, the rib has a different transverse section. The high H of the rib 18 is for example in the range of 2 mm to 50 mm. An example of rib material is a polyester distributed under DELMAT®.

In order to connect electrical components (not shown) the assembly 2 comprises at least one conducting connection terminal 20 in contact with the bar 4.

Each terminal 20 comprises a conducting sleeve 21 crimped into a corresponding trough hole 22 of the bar 4. The sleeve 21 protrudes on face 8. Each insulating film 10, 12 comprises an opening 23 aligned with the hole 22 and having a diameter larger than that of the hole 22, such that an annular region 24 surrounding the hole 20 of each face 6, 8 remains exposed to air.

In use, an electric terminal of an electric component (not shown), such as a resistor, a capacitor or an inductor, is fixed to terminal 20 and another electric terminal of the component is fixed to another conducting bar of another electric supply bar assembly (not shown).

Electric arcs may form between region 24 and an uncovered region of a conducting bar of another electric supply bar assembly.

Tracking propagation mode is critical since the resistance to propagation of electric arcs is lower in tracking propagation mode as compared to air propagation mode.

A path of an electrical arc propagating by tracking from region 24 and passing over rib 18 is illustrated in dotted line A on FIG. 1.

As it can be noticed, the length of path A is increased by twice the high H of rib 18 as compared to the length of path A in the absence of rib 18. Consequently, the rib 18 increases a tracking distance for electric arcs propagating on face 16 of film 16, and lower the chance of electric arcs propagation.

The rib 18 is preferably positioned on face 16 of film 12 on path along which electric arcs are the most likely to propagate.

Referring to FIGS. 2 and 3, the assembly 2 comprises several terminals 20, for example two terminals 20. The rib 18 extends rectilinearly beside terminals 20 (FIG. 2) for preventing tracking in one direction from the terminals 20, or surrounds the terminals 20 (FIG. 3) for preventing tracking in all directions from the terminals 20.

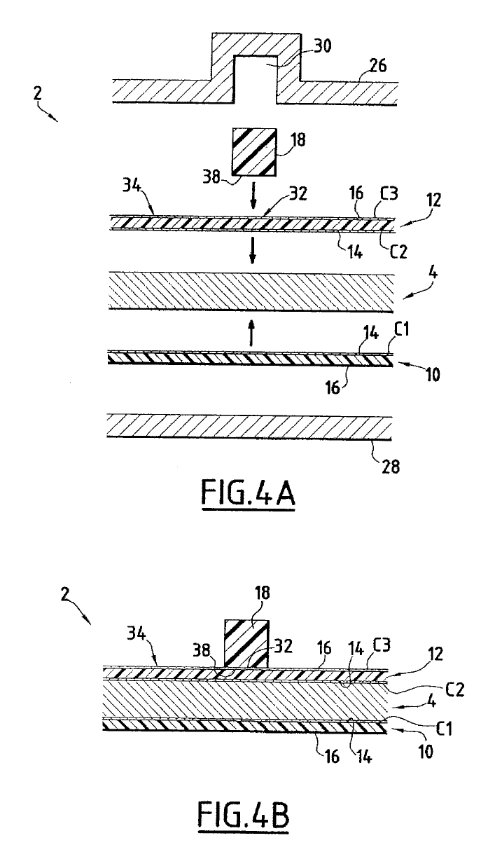

Referring to FIGS. 4A and 4B, a method for producing the assembly 2 is described in the following of the description.

In a first step, the film 10 is coated on its face 14 with a heat-sealable coating C1, and the film 12 is coated on both its faces 14 and 16 with heat-sealable coatings C2, C3, preferably of the same material as coating C1.

In a second step, the films 10 and 12 are placed onto faces 6 and 8, and the rib 18 is placed onto film 12.

In a third step, this stack is pressed and heated between an upper shell 26 and a lower shell 28 of a mold. The upper shell 26 has a cavity 30 for accommodating the rib 18 therein.

The heating activates the coatings C1, C2 and C3.

After a period of time, the films 10 and 12, the bar 4 and the rib 18 are bonded together, the shells 26, 28 are separated and the assembly 2 of FIG. 4B is obtained.

With this method, the assembly 2 is achieved with a limited number of steps, and at low cost. As a matter of fact, the bonding of the rib 18 is achieved during the same operations as the bonding of the films 10 and 12 to the bar 4.

Furthermore, in use, the assembly 2 encounters high voltage, high temperature, high humidity and/or high mechanical stress. Since the bonding between bar 4 and film 12 if of the same kind as the bonding between film 12 and rib 18 the assembly 2 will be adapted to resist to these severe work conditions.

The coatings C1, C2 and C3 can be coated on the films 10 and 12 with a substantially constant thickness, for example during a lamination-type process. The constant thickness ensures a better contact between the rib 18 and the film 12, and consequently a more resistant bonding.

The thickness of the coating C1, C2 and C3 is for example in the range of 20 mm to 50 μm.

The coatings C1, C2 and C3 are for example epoxy-based or silicone coatings.

The rib 18 is preferably made of the same material as film 12 so as to lower mechanical stress due to differential dilatation between film 12 and rib 18.

With the method, the rib 18 is in contact with a rib contact region 32 of film 12 confronting rib 18, and the remaining region 34 of film 12 is covered with the heat-sealable coating.

It is possible to provide means for preventing the heat-sealable coating from sticking to the film 12 to the shell 26, such as a Teflon® coating on the shell 26.

In an alternative, the heat-sealable coating is deposited on face 16 of the film 12 only on region 32.

In another alternative, the heat-sealable coating is deposited on a face 38 of the rib 18 confronting region 32.

During the production method, openings 23 and holes 22 (FIG. 1) are preferably cut out before the second step, and sleeve 21 (FIG. 1) is crimped after the third step.

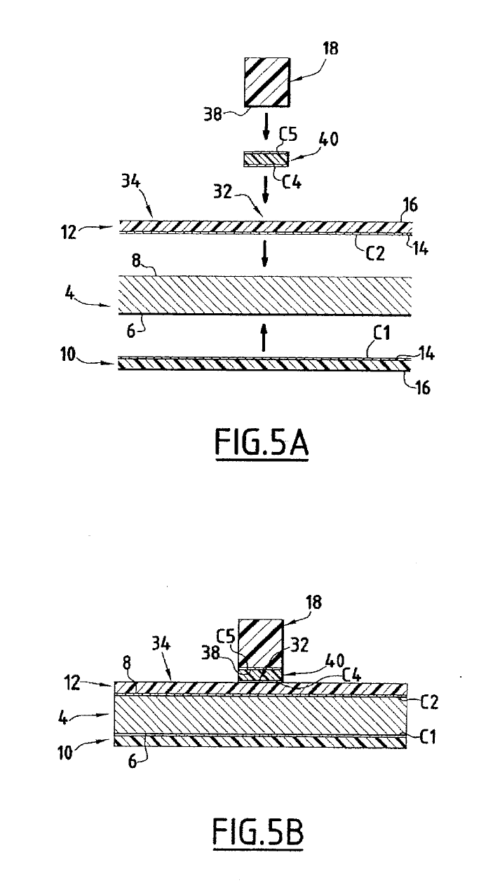

Another embodiment illustrated on FIGS. 5A and 5B, in which similar elements are designated by the same numeral references, differs from the embodiment of FIGS. 4A and 4B in that the face 16 of the film 12 is not covered with a heat-sealable coating, and in that an electrically insulating spacer 40 is interposed between rib 18 and the film 16.

In the method for producing the assembly, the spacer 40 is coated on opposed faces thereof with heat-sealable coatings C4, C5 at the first step, and interposed between rib 18 and region 32 at the second step.

After the third step, the spacer 40 will bond the rib 18 to the film 16. The region 34 is uncoated and will not stick to the mold shell 26.

Spacer 40 is preferably made of the same material as film 12 so as to lower mechanical stress due to differential dilatation. Preferably, coatings C4 and C5 are the same as coating C1.

Advantageously the spacer 40 is a piece of insulating film identical to films 10 and 12. For example, spacer 40 is cut out from a film coated with heat-sealable coating during a lamination-type process so as to obtain coatings C4 and C5 of substantially constant thickness.

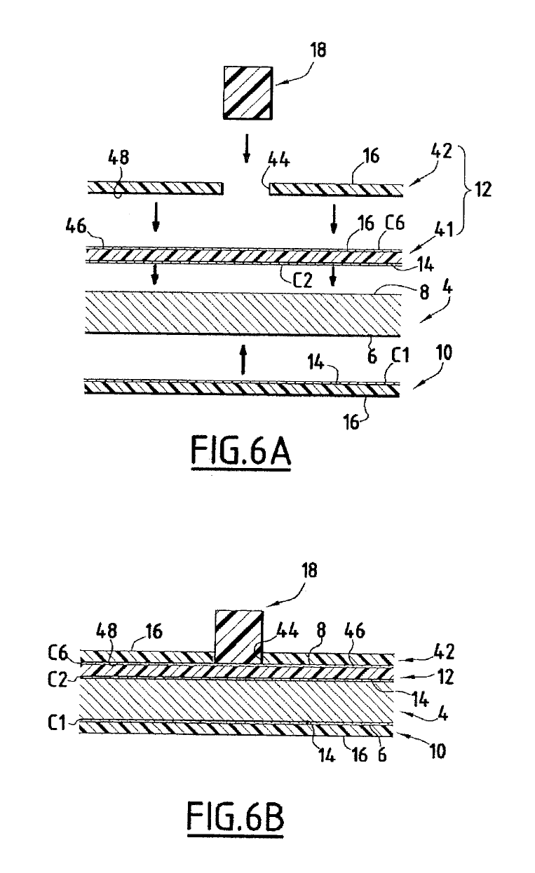

Another embodiment illustrated on FIGS. 6A and 6B, in which similar elements are designated by the same numeral references, differs from the embodiment of FIGS. 4A and 4B in that the film 12 is two-layered and has a base layer 41 in contact with the bar 4 and a cover layer 42 covering the base layer 41, said cover layer 42 being provided with an opening 44 having the shape of rib 18, which contacts the film 12 through the opening 44.

In the first step of the method for producing the assembly 2, heat-sealable coatings C2 and C6 are coated on the face 14 of the base layer 41 and on a face 46 of the base layer 41 confronting the cover layer 42. The face 16 of cover layer 42 opposite is free of heat-sealable coating. The opening 44 is cut out into film 42.

At the second step, the base layer 41 is placed onto bar 4, the cover layer 42 is applied the base layer 41, and the rib 18 is placed onto the base layer 41 through the opening 44.

During the third step, the rib 18 and the cover layer 42 adhere to base layer 41. The uncoated face 16 prevents from sticking to the mold shell 26.

The two-layered film 12 has the same thickness as film 10 or a larger thickness. For example, film 12 is made of two superimposed insulating films which are identical to film 10, and film 12 consequently has twice the thickness of film 10, whereby insulation of bar 4 is increased.

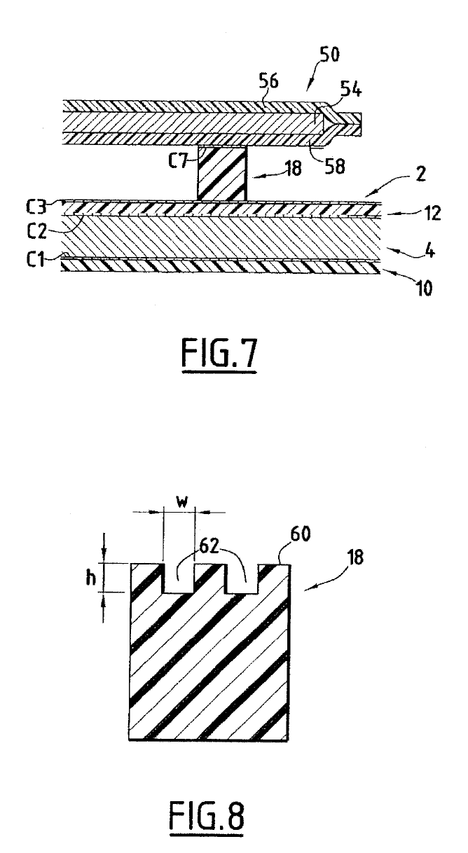

Another embodiment illustrated on FIG. 7, in which similar elements are designated by the same numeral references, differs from the embodiment of FIGS. 4A and 4B in that another electrical supply bar assembly 50 comprising an electrically conducting bar 54 covered with insulating films 56 and 58 is bonded to the upper extremity of the rib 18 opposite bar 4.

The assembly 50 may be bonded to the rib 18 using a heat-sealable coating C7 interposed between the rib 18 and the film 58.

The assembly 50 is bonded to the rib 18 during the third step of the method for producing the assembly 2, or in a subsequent step. In any case, temporary spacers should be interposed between the assemblies 2, 50 during a step of activating the heat-sealable coating between the assembly 50 and the rib 18.

In such an arrangement, the rib 18 has the first function of avoiding tracking of electric arcs and the second spacer function of maintaining a predetermined distance between the two bars 4, 54.

Referring to FIG. 8, in order to increase the insulating effect of the rib 18, the rib 18 is provided with one or more parallel grooves 62, for example two groove, to increase the tracking distance for electric arcs passing over the rib 18.

The grooves 62 of extend for example along a top 60 of the rib 18.

When passing over the rib 18, the electric arc has to cross over each groove 62, or to track to the bottom of each groove 62. It is therefore more difficult for the electric arc to pass the rib 18.

If the width w of the grooves 62 is sufficient enough as compared to the height h of the grooves 62, an electric arc is more likely to track down the grooves 62 rather that cross over the grooves. In this case, the tracking path is increased by twice the height h of each groove 62.

1. Electrical supply bar assembly comprising:
an electrically conducting bar,
a lower electrically insulating films and an upper electrically insulating film, respectively covering opposed faces of the conducting bar, and
an electrically insulating member bonded to the upper insulating film opposite to the conducting bar, the insulating member protruding on the exposed face of the upper insulating film so as to prevent propagation of electric arcs by tracking on said exposed face,
wherein the insulating member is bonded to the insulating film with a heat-sealable coating.

2. Electrical supply bar assembly according to claim 1, wherein the upper insulating film and lower insulating film are each bonded to the conducting bar with a heat-sealable coatings.

3. Electrical supply bar assembly according to claim 2, wherein the heat-sealable coating between the upper insulating film and the conducting bar is identical to the heat-sealable coating between the upper insulating film and the insulating member.

4. Electrical supply bar assembly according to claim 1, wherein the insulating member is made of the same material as the upper insulating film.

5. Electrical supply bar assembly according to claim 1, wherein a spacer is interposed between the upper insulating film and the insulating member.

6. Electrical supply bar assembly according to claim 6, wherein the spacer is bonded to each of the upper insulating film and the insulating member with a heat-sealable coating.

7. Electric supply bar assembly according to claim 5, wherein the spacer is made of the same material as the upper insulating film.

8. Electric supply bar assembly according to claim 1, wherein the upper insulating film comprises a base layer in contact with the conducting bar and a cover layer, the base layer being bonded by a heat-sealable coating to the conducting bar and to the cover layer, said cover layer having an opening through which the insulating member is bonded to the base layer by a heat-sealable coating disposed on a face of the base layer confronting the cover layer.

9. Electric supply bar assembly according to claim 1, wherein the insulating member comprises grooves on an exposed face of the insulating member so as to increase a tracking distance of an electric arc passing over the insulating member.

10. Method of producing an electrical supply bar assembly comprising the steps of:
bonding upper and lower insulating films over opposed faces of an electrically conducting bar, and
bonding an electrically insulating member on the upper insulating film, such that the insulating member protrudes on an exposed face of the upper insulating film so as to prevent propagation of electric arcs by tracking along said exposed face,
wherein the step of bonding the upper insulating film to the insulating member comprises the steps of providing a heat-sealable coating between the upper insulating film and the insulating member and activating said heat-sealable coating by heating.

11. Method according to claim 10, wherein the step of providing a heat-sealable coating between the upper insulating film and the insulating member comprises the steps of coating the face of the upper insulating film confronting the insulating member with a heat-sealable coating, and placing the insulating member on the upper insulating film.

12. Method according to claim 10, wherein the step of bonding the upper and lower insulating films to the conducting bar comprises the steps of providing heat-sealable coatings between the upper and lower insulating films and the conducting bar, and activating said heat-sealable coatings by heating.

13. Method according to claim 12, wherein the step of providing heat-sealable coatings between the upper and lower insulating films and the conducting bar comprises the steps of coating faces of the upper and lower insulating films confronting the conducting bar with heat-sealable coatings, and placing the insulating films on the conducting bar.

14. Method according to claim 12, wherein all of the heat-sealable coatings are activated by heating during the same activating step.

15. Method according to claim 10, wherein the upper insulating film comprises a base layer in contact with the conducting bar and a cover layer having an opening adapted to accommodate the insulating member, the method comprising the steps of coating opposed faces of the base layer with heat-sealable coatings, placing the base layer on the conducting bar, placing the cover layer on the base layer, and placing the insulating member in contact with the base layer through the opening of the cover layer, and activating the heat-sealable coatings in a subsequent step by heating.

16. Method according to claim 10, further comprising the steps of interposing an electrically insulating spacer between the insulting film and the insulating member and supplying heat-sealable coatings between the upper insulating film and the spacer, and between the spacer and the insulating member.
